(19) United States
(12) Patent Application Publication
(10) Pub. No.: US 2006/0178460 A1
(43) Pub. Date: Aug. 10, 2006

(54) Defoaming agent for liquid hydrocarbons II

(76) Inventors: David Herault, Koein (DE); Benoit Abribat, Loveland, OH (US); Frank Bongardt, Meerbusch (DE); Achim Pfeiffer, Duesseldorf (DE)

Correspondence Address: COGNIS CORPORATION;PATENT DEPARTMENT, 300 BROOKSIDE AVENUE, AMBLER, PA, 19002, US

(21) Appl. No.: 10/203,859

(22) PCT Filed: Feb. 6, 2001
(86) PCT No.: PCT/EP01/01240

§ 371 Date: Apr. 3, 2006

(30) Foreign Application Priority Data
Feb. 15, 2000 (DE) 100 06 624.0

(51) Int. Cl. C08K 5/10

(52) U.S. Cl. 524/284

(57) ABSTRACT

A process for inhibiting a liquid hydrocarbon from foaming involving: (a) providing a liquid hydrocarbon; (b) providing a defoamer additive containing: (i) an ester corresponding to formula (I)
R¹—COO—R² (I)
wherein R¹ and R² are, independent of each other, saturated or unsaturated, linear or branched alkyl radicals having from about 6 to 16 carbon atoms, as a defoamer; and (ii) optionally, a co-defoamer selected from the group consisting of a non-alkoxylated ester of a polyol having from about 2 to 6 carbon atoms, and from about 2 to 4 OH groups, a saturated or unsaturated, linear or branched fatty acid having from about 8 to 24 carbon atoms, and mixtures thereof; and (c) adding a foam-inhibiting effective amount of (b) to (a).

The present invention relates to the use of liquid esters for defoaming liquid hydrocarbons, a process for defoaming liquid hydrocarbons and also additives for defoaming liquid hydrocarbons.

In the field of lubricant technology, the high demands placed on lubricants today dictate not only that suitable base oils be used but also that their performance be supplemented and improved by various additives. Examples of such additives include oxidation inhibitors, viscosity index improvers, pour point depressants, detergents and dispersants, high pressure (HP) additives, friction modifiers and defoamers. The latter are required because many lubricant oils tend to foam which can sometimes drastically reduce the performance of the lubricant, in particular in closed lubricant circuits. Foaming of lubricants accordingly has to be avoided at all costs. The problem of foaming of lubricants is normally solved by incorporating foam inhibitors in the lubricants, for example, low molecular weight silicone oils or alkyl polyacrylates. Preference is given to using low molecular weight silicone oils such as polydimethylsiloxanes, fluorosilicones or silicone glycols for this purpose. However, silicones have the disadvantage that, in organic liquids which are then subjected to combustion, the reaction of the organosilicone polymer with oxygen leads to the formation of silicon oxides, which in finely divided form firstly cause environmental pollution and secondly lead to problems with filters and catalysts in the system to be lubricated. This problem occurs in particular in the automobile sector or more precisely in internal combustion engines. U.S. Pat. No. 3,166,508 discloses defoamers for hydrocarbons based on alkyl acrylate polymers having a molecular weight of less than 10 000. However, such defoamers show a lower foam-inhibiting effect than the prior art silicone oils. WO 94/06894 discloses reaction products of polyamines with carboxylic acids as defoamers or foam inhibitors for organic liquids. In this case, disadvantages occur in that insufficient long-term stabilities were detected and the products were in the form of fine particles, which complicates their use in lubricant oils in motor vehicles. Also, defoamers for lubricants, for example in gearboxes, have to maintain their effectiveness over a wide temperature range, frequently up to 80° C. or 100° C.

The object of the present invention, then, was to provide suitable defoamers for liquid hydrocarbons which do not have the abovementioned disadvantages. These shall in particular achieve defoaming performance on the order of magnitude of the known silicone defoamers, without the danger of formation of solid particles during combustion being observed. It was also required that the defoamer effect should be retained over a wide temperature range.

Surprisingly, it was found that certain liquid ester compounds fulfill the abovementioned requirements. A first part of the subject-matter of the present invention relates to the use of esters which are liquid at room temperature of the general formula (I)
R′—COO—R″ (I)
where R′ and R″ are independently saturated or unsaturated, linear or branched alkyl radicals having from 6 to 16 carbon atoms, as defoamers for liquid hydrocarbons. These esters are compounds known per se which can be synthesized by known organic chemistry processes. To this end, saturated or unsaturated monoalcohols of preferred chain length from C6 to C16 are esterified with monohydric, saturated or unsaturated carboxylic acids of chain length from C6 to C16, preferably from C8 to C12, for example in the presence of acid catalysts. Examples of useful alcohols include caproic alcohol, caprylic alcohol, pelargonyl alcohol, capric alcohol, lauryl alcohol, myristyl alcohol, palmityl alcohol and stearyl alcohol. Examples of useful unsaturated alcohols include oleyl alcohol, elaidyl alcohol, ricinoleyl alcohol, linoeyl alcohol or linolenyl alcohol. Branched alcohols, preferably 2-alkylalkanols, which may be obtained, for example, by the Guerbet synthesis, may also be used. Examples of useful monocarboxylic acids include caproic acid, caprylic acid, pelargonic acid, capric acid, lauric acid, myristic acid, palmitic acid and stearic acid. Useful unsaturated acids include lauroleic acid, myristoleic acid, palmitoleic acid, petroselic acid, petroselaidic acid, oleic acid, elaidic acid, ricinoleic acid and linoleic acid or linolenic acid and linoaidic acid. It has been shown that esters of the formula (I) where at least one alkyl radical R or R′ is olefinically mono- or polyunsaturated are preferred. Particular preference is given to esters of the formula (I) where both alkyl radicals R′ and R″ are mono- and/or polyunsaturated. Preference may also be given to both radicals R′ and R″ having the same chain length, i.e. to obtaining symmetrical compounds. In this context, particular preference is given to octyl octanoate as defoamer.

In the context of the present application, the term defoamer is used synonymously with the expression foam inhibitor or foam-preventing reagent. The effect of the present compound of the formula (I) can be regarded as the suppression of foam formation or the faster degradation of foam which is already formed.

The compound according to formula (I) are added to liquid hydrocarbon quantities in quantities of from 1 to 5000 ppm, preferably from 1 to 3000 ppm and in particular from 1 to 2500 ppm (based in each case on the active substance of the formula (I)). Particular preference is given to the range from 500 to 2500 ppm and 1000 to 2500 ppm. The esters used according to the invention show a defoaming effectiveness comparable to the known silicone compounds without their disadvantages, in particular the formation of solid particles. The esters used according to the invention are suitable for defoaming hydrocarbons which are liquid at room temperature (21° C.). In the present application, the term hydrocarbons is used in a wide sense. It does not only include crude oil raffinates, such as gasoline or diesel oil, but also base oils for lubricants in general which encompass not only polymers of olefins, condensation products of olefins or chloroparaffins with aromatics, and dechlorinated condensates of chloroparaffins, but also polyethers, carboxylic esters, phosphoric esters, phosphonic esters and also fluorinated compounds which are known to those skilled in the art as lubricants. Preference is given to using the compounds of the formula (I) for defoaming synthetic lubricants which comprise ester oils. The ester oils are compounds which are formed firstly from branched-chain primary alcohols and straight-chain dicarboxylic acids, from branched-chain monocarboxylic acids and straight-chain diols or polyalkylene glycols, from straight-chain primary alcohols and branched dicarboxylic acids or, in particular, from esters of neopentyl polyols with monocarboxylic acids. The alcohols required for preparing such ester oils are obtained from the oxo process or aldol condensation. In principle, all olefins are suitable for the oxo process, but for later use of the alcohols as ester oil components, preference is given to using tri- or tetrapropylene, diisobutene, mixed dimers of propylene and n-butene and also butenes or pentenes. The oxo process alcohols are esterified as isomer mixtures, whereas the alcohols obtained by aldol condensation, for example, the 2-ethylhexan-1-ol obtained from n-butanal, are esterified as a substantially unitary compound. The most important dicarboxylic acids are sebacic acid, adipic acid and azelaic acid. Perlagonic acid which, as well as azelaic acid, results from the oxidation of oleic acid, is available as a monocarboxylic acid. Sebacic acid is obtained by alkaline cleavage of ricinoleic acid. The esters are prepared from acid and alcohol in the presence of acid catalysts and with distillative removal of the water formed, using benzene or toluene. Particular importance attaches to what are known as the complex esters which are prepared using dicarboxylic acids, glycols (or polyglycols) and monocarboxylic acids of monoalcohols. Depending on the desired product, glycol and dicarboxylic acid are first esterified and the end groups of this intermediate, depending on the molar ratio of the two components, are either reacted with a monocarboxylic acid or a monoalcohol. The complex esters have higher molecular masses than the simple esters and accordingly substantially higher intrinsic viscosities. Further details of such compounds can be found, for example, in Ullmanns Encyklopädie der technischen Chemie, 4th edition, 1981, pages 514 ff. Further suitable lubricants include perfluoropolyalkyl ethers, tetrahydrofuran polymer oils, polythioether oils, polyphenyl ethers, ethylene and propylene polymers, polybutenes and polymers of higher olefins. The present compounds of the formula (I) are also suitable for defoaming mixtures of these different base oils.

According to the invention, the compounds of the general formula (I) are added directly to the lubricant or hydrocarbon to be defoamed. The hydrocarbons according to the present invention are generally water-free, i.e. they contain water in quantities of less than 1% by weight, preferably in the ppm range, in particular of less than 500 ppm. Where diesel and gasolines are concerned, preference is given to those hydrocarbons whose sulfur content is reduced. The sulfur content of such hydrocarbons is preferably below 50 ppm, in particular in the range of less than 10 ppm.

A further part of the subject matter of the invention relates to the combination of defoamers of the formula (I) with nonalkoxylated esters of polyols having from 2 to 6 carbon atoms and from 2 to 4 OH groups and saturated or unsaturated, linear or branched fatty acids having from 8 to 24 carbon atoms. It has been observed that the additional use of such compounds can have a synergistic effect on the defoaming performance. Preference is given to room temperature liquid triglycerides which are of natural, in particular plant, origin. Examples thereof include rapeseed oil, sunflower oil, soya oil, coconut oil and castor oil. Particular preference is given to combining defoamers of the formula (I) with solvents and the triglycerides, and the additional use of alkoxylated alcohols may also be preferable.

A further part of the subject-matter of the present invention relates to additives for defoaming lubricants, and the additives preferably contain a) from 1 to 99% by weight of a compound of the formula (I), b) from 1 to 10% by weight of the above-described polyol esters or preferably of triglycerides and optionally further additives in quantities of up to a maximum of 10% by weight. It is also possible and preferred to supplement the additives according to the invention by adding further additives known in the lubricant sector, for example, VI improvers, corrosion inhibitors, antioxidants, friction modifiers, HP additives, polymers, preferably vinyl polymers, etc., and to adapt their performance to the requirements of each practical use. The present invention also relates to a process for defoaming liquid hydrocarbons, wherein compounds of the formula (I) are added to the liquid hydrocarbons in quantities of from 1 to 5000 ppm (of active substance).

### EXAMPLES

In order to demonstrate the effectiveness of the technical teaching according to the invention, defoamer tests were carried out to ASTM D892. To this end, 200 ml of the hydrocarbon were prepared with the additives to be tested in the desired concentrations and heated to different temperatures. 190 ml of this solution are transferred to a 1000 ml upright cylinder. A gas distributor (sinter brick) is then saturated for five minutes and air is blown through the solution for two minutes (400 l per hour volume). The foam volume was read off (in ml) and noted. In the present case, two additives according to the invention in two transmission oils were investigated at 20, 60 and 90° C. As a comparison, the oils were measured without additives or with addition of a prior art silicone defoamer. The composition of the additives according to the invention is reported in table 1.

TABLE 1

| | Octyl | Coconut |
|---|---|---|
| | ocanoate | oil |
| | % by weight | % by weight |
| 1 | 99 | 1 |
| 2 | 100 | — |

TABLE 2

| | a: Transmission oil I | | | b: Transmission oil II | | |
|---|---|---|---|---|---|---|
| | 20° C. | 60° C. | 90° C. | 20° C. | 60° C. | 90° C. |
| | h (ml) | h (ml) | h (ml) | h (ml) | h (ml) | h (ml) |
| 1 | 120* | 250* | 500* | — | 100* | 240* |
| 2 | 90** | 110** | 190** | 50* | 90* | — |
| C | 90*** | 140*** | 350*** | 141*** | 270*** | 122**** |
| B | 530 | 900 | 1000 | 550 | 680 | >600 |

*500 ppm dose
**1000 ppm dose
***25 ppm dose
****100 ppm dose

The oils additivized according to the invention show distinctly better foaming behavior at different temperatures in comparison to nonadditivized oil. It becomes clear that the additives according to the invention even have comparable performance to the known, expensive silicone reference defoamers.

1-11. (canceled)

12. A process for inhibiting a liquid hydrocarbon from foaming comprising:
(a) providing a liquid hydrocarbon;
(b) providing a defoamer additive containing:
(i) an ester corresponding to formula (I)
R¹—COO—R² (I)
wherein R¹ and R² are, independent of each other, saturated or unsaturated, linear or branched alkyl radicals having from about 6 to 16 carbon atoms, as a defoamer; and
(ii) optionally, a co-defoamer selected from the group consisting of a non-alkoxylated ester of a polyol having from about 2 to 6 carbon atoms, and from about 2 to 4 OH groups, a saturated or unsaturated, linear or branched fatty acid having from about 8 to 24 carbon atoms, and mixtures thereof; and
(c) adding a foam-inhibiting effective amount of (b) to (a).

13. The process of claim 12 wherein in formula (I) R¹ and R², independently of each other, are alkyl radicals having from about 8 to 12 carbon atoms.

14. The process of claim 12 wherein R¹ and R² are selected from the group consisting of a mono-unsaturated alkyl radical, a poly-unsaturated alkyl radical, and mixtures thereof.

15. The process of claim 12 wherein both R¹ and R² have an identical number of carbon atoms.

16. The process of claim 12 wherein (i) is octyl octanoate.

17. The process of claim 12 wherein (b) is added to (a) in an amount of from about 1 to 5000 ppm.

18. The process of claim 12 wherein (b) is added to (a) in an amount of from about 1 to 3000 ppm.

19. The process of claim 12 wherein (b) is added to (a) in an amount of from about 1 to 2500 ppm.

20. The process of claim 12 wherein the liquid hydrocarbon is a lubricant.

21. The process of claim 12 wherein the co-defoamer is present in (b) in an amount of from about 1 to 10% by weight, based on the weight of the defoamer additive.

22. The process of claim 12 wherein the co-defoamer is a triglyceride of natural origin.

23. A low-foaming liquid hydrocarbon composition comprising:
(a) a liquid hydrocarbon; and
(b) a defoaming additive containing:
(i) an ester corresponding to formula (I):
R¹—COO—R² (1)
wherein R¹ and R² are, independent of each other, saturated or unsaturated, linear or branched alkyl radicals having from about 6 to 16 carbon atoms; and
(ii) optionally, a co-defoamer selected from the group consisting of a non-alkoxylated ester of a polyol having from about 2 to 6 carbon atoms, and from about 2 to 4 OH groups, a saturated or unsaturated, linear or branched fatty acid having from about 8 to 24 carbon atoms, and mixtures thereof.

24. The composition of claim 23 wherein in formula (I) R¹ and R² independently of each other, are alkyl radicals having from about 8 to 12 carbon atoms.

25. The composition of claim 23 wherein R¹ and R² are selected from the group consisting of a mono-unsaturated alkyl radical, a poly-unsaturated alkyl radical, and mixtures thereof.

26. The composition of claim 23 wherein both R¹ and R² have an identical number of carbon atoms.

27. The composition of claim 23 wherein the ester is octyl octanoate.

28. The composition of claim 23 wherein the ester is present in the composition in an amount of from about 1 to 5000 ppm, based on the weight of the composition.

29. The composition of claim 23 wherein the ester is present in the composition in an amount of from about 1 to 3000 ppm, based on the weight of the composition.

30. The composition of claim 23 wherein the ester is present in the composition in an amount of from about 1 to 2500 ppm, based on the weight of the composition.

31. The composition of claim 23 wherein the liquid hydrocarbon is a lubricant.

32. The composition of claim 23 wherein the co-defoamer is present in the composition in an amount of from about 1 to 10% by weight, based on the weight of the defoamer additive.

33. The composition of claim 23 wherein the co-defoamer is a triglyceride of natural origin.
